(19) United States
(12) Patent Application Publication
(10) Pub. No.: US 2024/0354363 A1
(43) Pub. Date: Oct. 24, 2024

(54) IDENTIFYING QUADRATIC PROGRAMMING SOLUTIONS

(71) Applicant: QUALCOMM Incorporated, San Diego, CA (US)

(72) Inventors: Pierre-David LETOURNEAU, Austin, TX (US); Rania HASSEN, Milton (CA); Gary MCGRATH, Carlsbad, CA (US); Matthew Harper LANGSTON, Beacon, NY (US)

(21) Appl. No.: 18/639,845

(22) Filed: Apr. 18, 2024

Related U.S. Application Data
(60) Provisional application No. 63/497,922, filed on Apr. 24, 2023.

(51) Int. Cl. G06F 17/11

(52) U.S. Cl. CPC G06F 17/11

(57) ABSTRACT

Methods, systems, and media for solving quadratic optimization problems are disclosed herein. In some embodiments, a method may involve receiving, by one or more processors, a first quadratic optimization problem comprising an objective and a set of inequality constraints. The method may involve obtaining an initial solution to the first quadratic optimization problem subject to the set of inequality constraints. The method may involve identifying a subset of the set of inequality constraints that are active constraints with respect to an optimal solution. The method may involve obtaining an updated solution to the first quadratic optimization problem by solving a second quadratic optimization problem that corresponds to optimizing the objective subject to the active constraints. The method may involve determining an accuracy and precision associated with the updated solution.

### CROSS-REFERENCE TO RELATED APPLICATIONS

This application claims priority under 35 U.S.C. § 119 to U.S. Provisional Application No. 63/497,922, filed on Apr. 24, 2023, the contents of which are hereby incorporated by reference in its entirety for all purposes.

### BACKGROUND

### 1. Field of Invention

The present invention relates generally to the field of optimization, and more particularly, to identifying quadratic programming solutions.

### 2. Description of Related Art

Optimization problems, such as quadratic programming problems, may be solved by various control systems, such as those of an autonomous vehicle, a drone, an aircraft, etc. Obtaining a solution to such an optimization problem may be computationally intensive. Moreover, for certain classes of optimization problems, there may be error associated with an obtained solution.

### BRIEF SUMMARY

An example method of solving quadratic programming optimization problems, according to this disclosure, comprises: receiving, by one or more processors, a first quadratic optimization problem comprising an objective and a set of inequality constraints; obtaining, by the one or more processors, an initial solution to the first quadratic optimization problem subject to the set of inequality constraints; identifying, by the one or more processors, a subset of the set of inequality constraints that are active constraints with respect to an optimal solution; obtaining, by the one or more processors, an updated solution to the first quadratic optimization problem by solving a second quadratic optimization problem that corresponds to optimizing the objective subject to the active constraints; and determining, by the one or more processors, an accuracy and precision associated with the updated solution.

An example device for solving quadratic optimization problems, according to this disclosure, comprises one or more memories, and one or more processing units communicatively coupled with the one or more memories. The one or more processing units may be configured to: receive a first quadratic optimization problem comprising an objective and a set of inequality constraints; obtain an initial solution to the first quadratic optimization problem subject to the set of inequality constraints; identify a subset of the set of inequality constraints that are active constraints with respect to an optimal solution; obtain an updated solution to the first quadratic optimization problem by solving a second quadratic optimization problem that corresponds to optimizing the objective subject to the active constraints; and determine an accuracy and precision associated with the updated solution.

An example device for solving quadratic optimization problems, according to this disclosure, comprises: means for receiving a first quadratic optimization problem comprising an objective and a set of inequality constraints; means for obtaining an initial solution to the first quadratic optimization problem subject to the set of inequality constraints; means for identifying a subset of the set of inequality constraints that are active constraints with respect to an optimal solution; means for obtaining an updated solution to the first quadratic optimization problem by solving a second quadratic optimization problem that corresponds to optimizing the objective subject to the active constraints; and means for determining an accuracy and precision associated with the updated solution.

An example non-transitory computer-readable medium storing instructions for solving quadratic programming optimization problems, according to this disclosure, may store instructions comprising code for: receiving a first quadratic optimization problem comprising an objective and a set of inequality constraints; obtaining an initial solution to the first quadratic optimization problem subject to the set of inequality constraints; identifying a subset of the set of inequality constraints that are active constraints with respect to an optimal solution; obtaining an updated solution to the first quadratic optimization problem by solving a second quadratic optimization problem that corresponds to optimizing the objective subject to the active constraints; and determining an accuracy and precision associated with the updated solution.

### BRIEF DESCRIPTION OF THE DRAWINGS

FIG. 1 is a graph of an example quadratic optimization problem, according to an embodiment.

FIG. 2 is a block diagram of a system that includes a control system and an optimization engine, according to an embodiment.

FIG. 3 is a flow diagram of an example method for determining solutions to quadratic programming problems and determining a precision associated with a given solution, according to an embodiment.

FIG. 4 is a flow diagram of an example method for determining solutions to quadratic programming problems, according to an embodiment.

FIG. 5 is a flow diagram of an example method for determining an accuracy and precision associated with a solution to a quadratic programming problem, according to an embodiment.

FIG. 6 is a block diagram of an embodiment of a computing device, which can be utilized in embodiments as described herein.

Like reference symbols in the various drawings indicate like elements, in accordance with certain example implementations.

### DETAILED DESCRIPTION

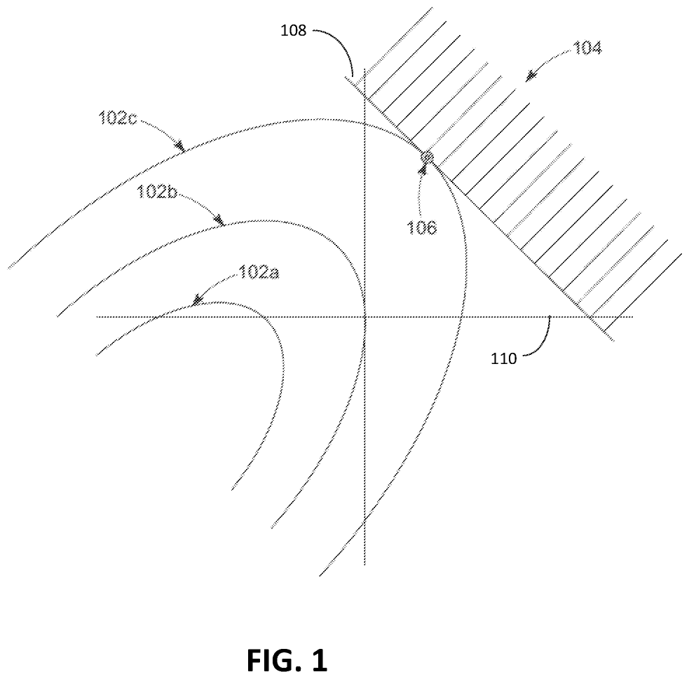

FIG. 1 depicts a graph representing an example quadratic optimization, or quadratic programming problem. As used herein, a “quadratic optimization” or “quadratic programming” problem (which may be used interchangeably) refers to optimizing a quadratic function of N variables subject to linear constraints. The linear constraints may be equalities and/or inequalities. FIG. 1 illustrates candidate solutions to a quadratic function (i.e., an unconstrained quadratic optimization problem), where the possible solutions are depicted by contour curves 102a, 102b, and 102c. It should be understood that contour curves 102a, 102b, and 102c depict candidate solutions of the quadratic function without being subject to any constraints. In instances in which the quadratic function is to be minimized or maximized, the function may be referred to as an objective. Note that although three possible solutions are depicted in FIG. 1, there may be an infinite number of possible solutions.

Also shown in FIG. 1 is a feasible region 104. Feasible region 104 indicates a region that satisfies a set of constraints. A feasible region may be bounded by any suitable number of constraints (e.g., zero, one, two, three, ten, twenty, one hundred, etc.). In general, a goal of the quadratic programming problem is to optimize (e.g., minimize or maximize) the quadratic function (depicted by curves 102a, 102b, and 102c) subject to the constraints. Note that, of curves 102a, 102b, and 102c, only curve 102c includes a point (e.g., point 106) that is on or in feasible region 104. Accordingly, point 106 may be considered a solution of the quadratic programming problem, because point 106 is a solution of the quadratic function and is within feasible region 104.

Of a given set of constraints, and given a solution to the unconstrained quadratic optimization problem, a constraint of a set of constraints may be considered an “active constraint” if the evaluation of the constraint at the solution is 0. In contrast, if the evaluation of the constraint at the solution is greater than 0, the constraint is satisfied, but the constraint is not considered an active constraint. Note that, if the evaluation of the constraint at the solution is less than 0, the constraint is considered not satisfied, and thus, the solution to the unconstrained quadratic optimization problem is not a proper solution of the constrained quadratic optimization problem subject to the given set of constraints.

Referring to FIG. 1, a constraint associated with line 108 may be considered an active constraint for solution 106, because solution 106 is exactly on line 108. In contrast, a constraint associated with line 110 may be considered a satisfied but inactive constraint for solution 106, because solution 106 is above the line, but not on the line.

Existing quadratic programming algorithms may identify a solution that nominally optimizes a quadratic function subject to linear constraints. For example, the Goldfarb-Idnani algorithm utilizes an iterative approach to identity a solution that satisfies the constraints. The Goldfarb-Idnani algorithm utilizes an iterative sequence of matrix operations to refine an identified solution from the previous iteration. Because the Goldfarb-Idnani algorithm utilizes iterative matrix operations, each successive matrix operation may compound error from a previous error. Accordingly, the solution identified at the end of the Goldfarb-Idnani algorithm may not in fact be an optimal solution, and there may be one or more solutions that are superior to the solution identified by the Goldfarb-Idnani algorithm. Moreover, because errors introduced at each successive iteration compound, there may be substantial error in the identified solution, and, the degree of error is not quantified by the Goldfarb-Idnani algorithm.

Solutions to quadratic programming problems may be utilized by various control systems, such as those used by autonomous vehicles (e.g., cars, aircraft, etc.) and/or drone systems (e.g., aerial drones, aquatic drones, etc.). Solutions to such quadratic programming problems may be utilized in trajectory planning of an autonomous vehicle, control of acceleration and/or deceleration, avoidance of objects (e.g., pedestrians, other vehicles, road construction objects, etc.), and the like. Quadratic programming problems may be solved multiple times per second, and an associated control system may utilize the solution to control a system or machine, such as the autonomous vehicle or the drone system. For example, based on the quadratic programming solution, a control system of an autonomous car or truck may cause brakes to be actuated, cause the car or truck to turn to avoid an object, or the like. However, because conventional techniques for solving quadratic programming problems may arrive at a non-optimal solution, and because the identified solution has an associated error that is not quantified, it is difficult for a control system to characterize the certainty of decisions based on a solution to a quadratic programming problem determined using conventional techniques. For example, a control system may obtain a solution to a quadratic programming problem using conventional techniques, where the solution may indicate, e.g., a predicted or estimated distance to a road object to be avoided. However, the error associated with the identified solution is unknown. If the error, or precision level of the solution were known, the control system would be enabled to make decisions based at least in part on the error. For example, if an error associated with a distance to a road object to be avoided is 5 millimeters, a control system of an autonomous car or truck may be able to instruct one or more operations to be performed with a high degree of confidence. Conversely, if the error is twenty feet, the control system may avoid instructing various operations due to low confidence in the solution.

Disclosed herein are systems, methods, media, and techniques for identifying solutions of a quadratic programming problem and quantifying an accuracy or precision level associated with the identified solution. In particular, a solution may be identified by first obtaining an initial solution to the quadratic programming problem and determining a set of active constraints associated with the initial solution. As used herein, an “initial solution” refers to a solution to a quadratic optimization problem obtained via a full execution of a given quadratic optimization algorithm, where the initial solution is subject to the set of constraints. For example, the initial solution may be identified using the Goldfarb-Idnani algorithm. An updated solution may then be determined by optimizing the quadratic function or objective subject to only the active constraints. By reducing a complexity of the optimization problem, the updated solution may be quickly identified. Moreover, the updated solution may be guaranteed to be at least as good as the initial solution. Note that, in some instances, there may be a relationship between the accuracy of the updated solution and the number of active constraints. For example, fewer active constraints may lead to a better accuracy of the updated solution relative to a scenario with more active constraints. Additionally, an error, or precision level, associated with the updated solution may be determined. The accuracy or precision level may be determined based on errors associated with each matrix operation performed to obtain the updated solution.

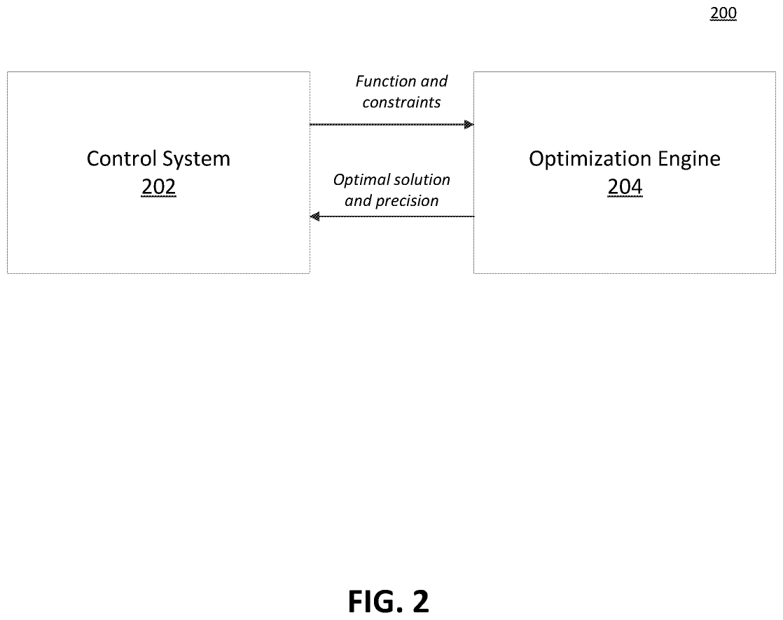

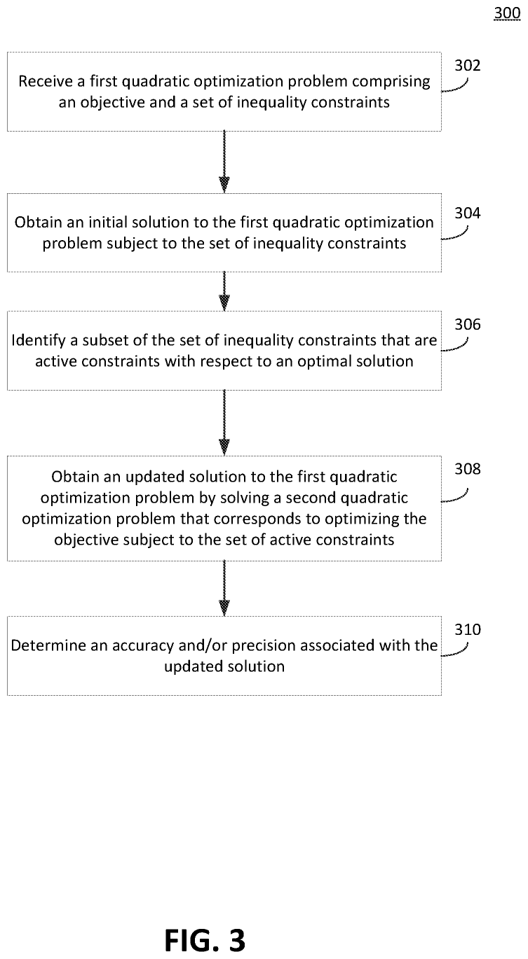

FIG. 2 is a block diagram of an example system 200 in accordance with some embodiments. System 200 may be part of an autonomous vehicle, such as an autonomous car, truck, drone, aircraft, or the like. System 200 may include a control system 202, which may be configured to identify optimization problems to be solved, determine a course of action or set of operations to be undertaken based on a determined solution to an optimization problem, transmit instructions to other components of system 200 (e.g., a braking system, an acceleration system, a turning system, etc.) based on the determined set of operations, or the like. In some embodiments, control system 202 may be configured to communicate with an optimization engine 204. In some embodiments, control system 202, optimization engine 204, or both, may be implemented by one or more of processing unit(s) 610 and/or DSP 620. For example, as illustrated in FIG. 2, control system 202 may transmit data indicative of a quadratic programming objective to be optimized and associated constraints. Optimization engine 204 may be configured to determine a final solution to the quadratic programming problem, and transmit this solution and associated precision to control system 202. For example, in some implementations, optimization engine 204 may implement any of the methods shown in and described below in connection with FIGS. 3 and/or 4 to determine the solution, and any of the methods shown in and described below in connection with FIGS. 3 and/or 5 to determine an accuracy or precision associated with the solution. Responsive to receiving the solution and the precision level associated with the solution, control system 202 may make one or more decisions based on a combination of the solution and the precision level. The one or more decisions may include a decision to modify a current operating mode of an autonomous vehicle associated with system 200, maintain a current operating mode of an autonomous vehicle associated with system 200, obtain additional data with which to make additional decisions, or the like.

In some implementations, a solution to a quadratic programming problem may be obtained by first obtaining an initial solution subject to a set of linear inequalities. The initial solution may be obtained using a conventional quadratic programming algorithm, such as the Goldfarb-Idnani algorithm. In conjunction with determining the initial solution, the active constraints associated with the initial solution may also be determined using the conventional quadratic programming algorithm (e.g., the Goldfarb-Idnani algorithm). The solution to the quadratic programming problem may then be determined by solving a second quadratic programming problem that corresponds to optimizing the initial objective subject to only the active constraints. An accuracy or precision associated with the solution may be determined based on error bounds associated with each matrix operation used to determine the solution to the second quadratic programming problem.

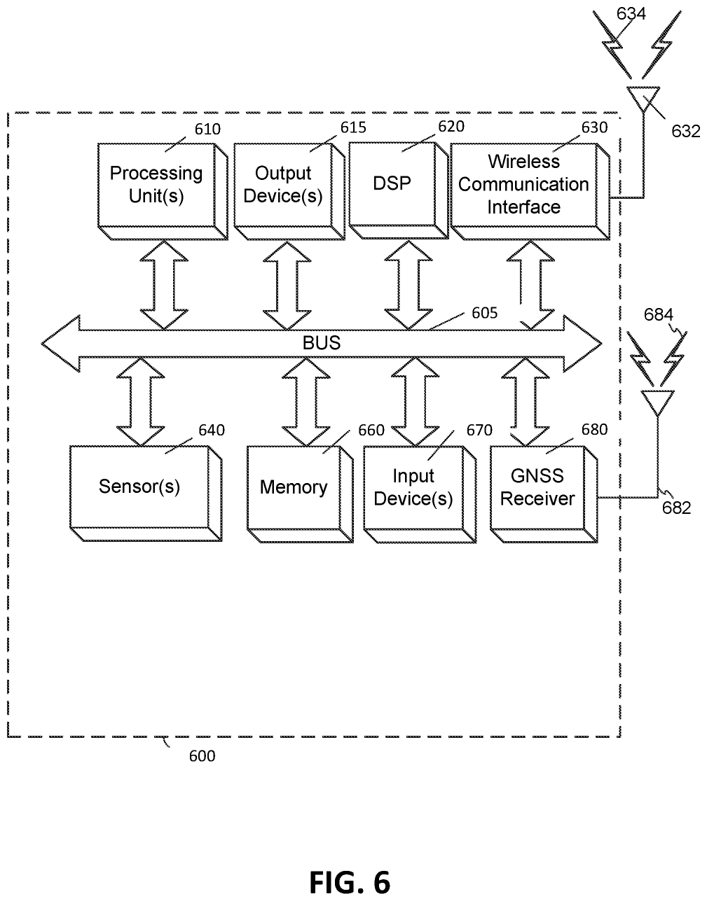

FIG. 3 is a flowchart of a process 300 for determining a solution to a quadratic programming problem and a precision in accordance with some embodiments. Means for implementing blocks of process 300 include one or more components of a computing device, such as processing unit of an autonomous vehicle or other control system, a server device, or the like. In some implementations, blocks of process 300 may be implemented by a control system and an optimization engine, as shown in and described above in connection with FIG. 2. An example of such a computing device and its components is shown in and described below in connection with FIG. 6.

Process 300 can begin at 302 by receiving a first quadratic optimization problem comprising an objective and a set of inequality constraints. Means for performing the functionality of block 302 may include a processing unit, such as processing unit 610, as shown in and described below in connection with FIG. 6. The quadratic optimization problem may be to minimize or maximize quadratic function subject to the inequality constraints. For example, the quadratic optimization problem may be represented as:

$$minimize f ( x ) = {a}^{T} x + \frac{1}{2} {x}^{T} Gx ,$$

$$subject to s = {C}^{T} x - b \geq 0$$

In the equation given above, x and a are vectors having length n (where n may be one, two, ten, one hundred, etc.), G is an n×n symmetric positive definite matrix, C is a matrix having dimensions n×m, and b is a vector having length m (where m may be one, two, ten, one hundred, etc.). The index n represents the number of dimensions of the quadratic optimization problem, and the index m represents the number of linear constraints.

At 304, process 300 can obtain an initial solution to the first quadratic optimization problem subject to the set of inequality constraints. Means for performing the functionality of block 304 may include a processing unit, such as processing unit 610, as shown in and described below in connection with FIG. 6. In some implementations, the initial solution may be obtained using a conventional quadratic programming algorithm, such as the Goldfarb-Idnani algorithm.

At 306, process 300 can identify a subset of the inequality constraints that are active constraints with respect to an optimal solution. Means for performing the functionality of block 306 may include a processing unit, such as processing unit 610, as shown in and described below in connection with FIG. 6. As described above, the active constraints may be those that, when the quadratic function is evaluated at the initial solution, the value lies on the active constraint. In some embodiments, the indices of vector b that correspond to the active constraints may be represented in vector A. Note that in instances in which the Goldfarb-Idnani algorithm is used at block 304 to obtain the initial solution, the Goldfarb-Idnani algorithm may generate, as a final output, a “solution pair,” or “S-pair,” comprising the initial solution x and vector A. Note that vector A represents a vector that indicates the indices of the active constraints.

At 308, process 300 can obtain an updated solution to the quadratic optimization problem by solving a second quadratic optimization problem that corresponds to optimizing the objective (e.g., as received at block 302) subject to the active constraints. Means for performing the functionality of block 302 may include a processing unit, such as processing unit 610, as shown in and described below in connection with FIG. 6. For example, in some embodiments, the updated solution may be obtained by solving the following quadratic optimization problem:

$$min {a}^{T} x + \frac{1}{2} {x}^{T} Gx$$

$$subject to {C}_{A}^{T} x = {b}_{A}$$

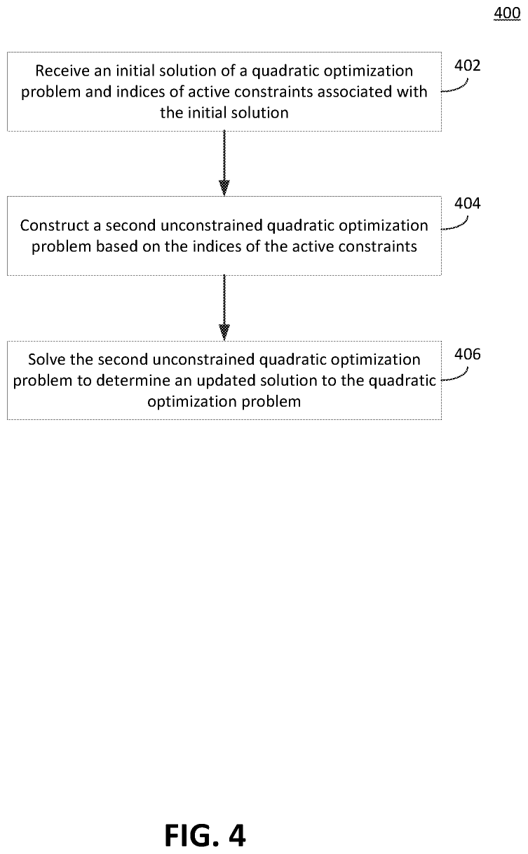

In the equation given above, C_{A}^{T} represents the restriction of matrix C to the active constraint indices specified by vector A, and b_{A} represents the restriction of vector b to the indices present in vector A. Note that the second quadratic optimization problem has equality constraints due to restricting the second quadratic optimization problem to only the active constraints. Additionally, note that obtaining the updated solution by solving the second quadratic optimization problem may essentially correspond to re-computing the solution under the set of active constraints. Because reducing the set of constraints may simplify the problem, the second quadratic optimization problem may be better-conditioned than the initial quadratic optimization problem solved at block 304 and may therefore yield an updated solution with less error than the initial solution. Note that more detailed techniques for determining the updated solution by solving the second quadratic optimization problem are shown in and described below in connection with FIG. 4.

It should be noted that, in some implementations, the initial solution (obtained at block 304) and the subset of active constraints (e.g., obtained at block 306) may be obtained using a smaller bit width computation than the bit width used to determine the updated solution (e.g., obtained at block 308). For example, in some embodiments, the initial solution and the subset of active constraints may be obtained using 32-bit computation, whereas the updated solution may be obtained using 64-bit computation. Using different bit width computations for determining the initial solution and the subset of active constraints may allow for greater overall speed in identifying the active set of constraints (e.g., where less precision may be needed) while also allowing for improved precision in the updated solution.

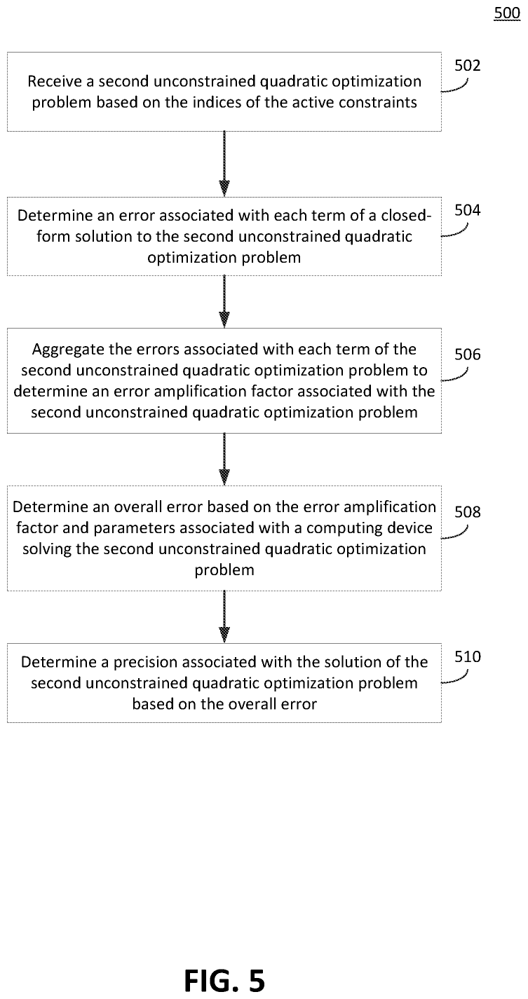

At 310, process 300 can determine an accuracy and/or precision associated with the updated solution. Means for performing the functionality of block 310 may include a processing unit, such as processing unit 610, as shown in and described below in connection with FIG. 6. In general, as used herein, an “accuracy” may refer to a distance of a prediction or estimation (e.g., the updated solution) with respect to an unknown ground truth. For example, in an instance in which the updated solution is a distance from a target, the accuracy may also be in distance units. As used herein, “precision” may refer to the number of digits a quantity is expressed in. In some implementations, process 300 can determine the accuracy and/or precision based on error bounds associated with the one or more matrix operations used to determine the updated solution. In some implementations, the accuracy and/or precision may additionally be determined based on characteristics of the computing device used to determine the updated solution, for example, an address width of the computing device (e.g., whether the computing device is a 32-bit computing device, a 64-bit computing device, or the like). For example, in some embodiments, a precision may be estimated based on a bit-width associated with a binary format of a particular computing device. Continuing with this example, an accuracy of a given solution may be estimated based on the precision. More detailed techniques for determining the accuracy and/or precision are shown in and described below in connection with FIG. 5.

Note that, in some embodiments, a change of variable (COV) regularization (sometimes referred to as “preconditioning”) may be performed with respect to the originally posed quadratic optimization problem. In particular, because the original system of equations may include variables that have values spanning a wide range in magnitude, the original system may be associated with a matrix G that is ill-conditioned or poorly conditioned, which may cause large errors. The matrix G may be linearly scaled using a diagonal matrix, and x may be re-written in terms of a new variable y. The scaling matrix D may be a diagonal matrix with values corresponding to the square root of the Hessian matrix. The change of variables may result in a completely equivalent system but with different matrix conditioning properties, which in turn may lead to more precise results in the optimal solution. After performing the COV regularization on the originally posed quadratic optimization problem (e.g., by performing the change of variable between blocks 302 and 304 of process 300 shown in and described above in connection with FIG. 3, the quadratic optimization problem using the changed variable may be solved as described above, e.g., using blocks 304-308 as shown in and described above in connection with FIG. 3. After obtaining the updated solution using the quadratic optimization problem with the changed variables (e.g., at block 308), the change of variables may be reversed.

In some embodiments, COV regularization may be performed responsive to determining that an originally posed quadratic optimization problem meets particular criteria. For example, on some embodiments, the condition number of matrix G of the originally posed quadratic optimization problem may be compared to a threshold, and COV regularization may be performed responsive to the condition number exceeding the threshold. Note that, in some embodiments, the threshold may be used-specified, e.g., by a customer.

By way of example, consider an initial quadratic optimization problem represented by:

$$minimize f ( x ) = {a}^{T} x + \frac{1}{2} {x}^{T} Gx ,$$

$$subject to s = {C}^{T} x - b \geq 0$$

Note that the equations given above correspond to the initial quadratic optimization problem described above in connection with block 302 of FIG. 3.

COV regularization may be performed by transforming variable x to variable y using:

y=Dx

In general, matrix D may be an invertible matrix that is constructed based on matrix G and/or the properties of matrix G. In some embodiments, D may be a diagonal matrix with elements that are a function of the Hessian, Dᵢᵢ=f(Gᵢᵢ). Note that the elements of D are real and well-defined since the operands are positive. After the change of variables, the initial quadratic optimization problem is then equivalent to:

$$minimize \frac{1}{2} {y}^{T} ( {D}^{- 1} {GD}^{- 1} ) y + ( {a}^{T} {D}^{- 1} ) y ,$$

$$subject to ( {C}^{T} {D}^{- 1} ) y - b \geq 0$$

In some embodiments, D may be a diagonal matrix with elements Dᵢᵢ=\sqrt{Gᵢᵢ}.

In some embodiments, D may be a diagonal matrix

$${D}_{ii} = 2 \frac{{log}_{2} ( {G}_{ii} )}{2} .$$

Note that the quadratic optimization problem given above using the variable y may be solved using the techniques described above, e.g., by obtaining an initial solution to the quadratic optimization problem (e.g., using the Goldfarb-Idnani algorithm), and then finding an updated solution to the quadratic optimization problem by optimizing the objective subject to the set of active constraints (e.g., as described above in connection with blocks 304-308 of FIG. 3).

After obtaining the updated solution, the change of variable can be reversed to obtain the solution to the original quadratic optimization problem. In particular, the change of variable can be reversed using:

$${x}^{*} = {D}^{- 1} {y}^{*}$$

In the equation given above, y* corresponds to the updated solution to the optimization problem when solved using the change of variable, and x* represents the updated solution using the original variables. Note that, in the equation given above, matrix D corresponds to the invertible matrix D described above used to perform the variable transformation.

FIG. 4 is a flowchart of a process 400 for determining a solution to a quadratic programming problem in accordance with some embodiments. Means for implementing blocks of process 400 include one or more components of a computing device, such as processing unit of an autonomous vehicle or other control system, a server device, or the like. In some implementations, blocks of process 400 may be implemented by a control system and an optimization engine, as shown in and described above in connection with FIG. 2. An example of such a computing device and its components is shown in and described below in connection with FIG. 6.

Process 400 can begin at 402 by receiving an initial solution of a quadratic optimization problem and indices of active constraints associated with the initial solution. Means for performing the functionality of block 402 may include a processing unit, such as processing unit 610, as shown in and described below in connection with FIG. 6. As described above, the indices of the active constraints may be represented by the vector A. Note that, because the initial solution is not used to compute the updated solution, in some implementations, process 400 may receive only the indices of the active constraints and not the initial solution.

At 404, process 400 can construct a second, unconstrained quadratic optimization problem based on the indices of the active constraints. Means for performing the functionality of block 404 may include a processing unit, such as processing unit 610, as shown in and described below in connection with FIG. 6. For example, as described above, the second quadratic optimization problem may correspond to optimizing the quadratic function subject to only the active constraints. As a more particular example, the second quadratic optimization problem may correspond to:

$$min {a}^{T} x + \frac{1}{2} {x}^{T} Gx$$

$$subject to {C}_{A}^{T} x = {b}_{A}$$

The quadratic optimization problem above may have any solution x of C_{A}^{T}x=b_{A} is of the form x=x_{A}+M_{C}_{_{A}}y, where y is any real-valued vector. In some embodiments, x_{A} can be taken as any solution while the range of M_{C}_{_{A}} spans the null space of C_{A}^{T}. As used herein, C_{A} represents the matrix which columns correspond to normals of the active constraints at optimality. In other words, the constraints are of the form C_{A}^{T}x*=b, where x* represents an optimal solution. Accordingly, the second, unconstrained quadratic optimization problem may be represented as:

$$min {a}^{T} ( {x}_{A} + {M}_{{C}_{A}} y ) + \frac{1}{2} {( {x}_{A} + {M}_{{C}_{A}} )}^{T} G ( {x}_{A} + {M}_{{C}_{A}} y )$$

At 406, process 400 may solve the unconstrained quadratic optimization problem to determine an updated solution to the quadratic optimization problem. Means for performing the functionality of block 406 may include a processing unit, such as processing unit 610, as shown in and described below in connection with FIG. 6. For example, the unconstrained quadratic optimization problem may be solved by determining y* by:

$${y}^{*} = - {( {M}_{{C}_{A}}^{T} {GM}_{{C}_{A}} )}^{- 1} {M}_{{C}_{A}}^{T} ( a + {Gx}_{a} )$$

The updated solution, represented herein as x*, may be determined by:

$${x}^{*} = {x}_{A} + {M}_{{C}_{A}} {y}^{*} = {x}_{A} - {{M}_{{C}_{A}} ( {M}_{{C}_{A}}^{T} {GM}_{{C}_{A}} )}^{- 1} {M}_{{C}_{A}}^{T} ( a + {Gx}_{A} )$$

Note that, to solve the equation given above, a series of matrix operations is performed to obtain x*. Error bounds associated with the series of matrix operations may be used to determine the accuracy and/or precision associated with the updated solution, as shown in and described below in connection with FIG. 5.

FIG. 5 is a flowchart of a process 500 for determining an accuracy and/or precision associated with a solution to a quadratic programming problem in accordance with some embodiments. Means for implementing blocks of process 500 include one or more components of a computing device, such as processing unit of an autonomous vehicle or other control system, a server device, or the like. In some implementations, blocks of process 500 may be implemented by a control system and an optimization engine, as shown in and described above in connection with FIG. 2. An example of such a computing device and its components is shown in and described below in connection with FIG. 6.

Process 500 can begin at block 502 by receiving a second unconstrained quadratic optimization problem based on the indices of active constraints associated with a first quadratic optimization problem. Means for performing the functionality of block 502 may include a processing unit, such as processing unit 610, as shown in and described below in connection with FIG. 6. As described above in connection with block 404 of FIG. 4, the second quadratic optimization problem may be represented by:

$$min {a}^{T} ( {x}_{A} + {M}_{{C}_{A}} y ) + \frac{1}{2} {( {x}_{A} + {M}_{{C}_{A}} y )}^{T} G ( {x}_{A} + {M}_{{C}_{A}} y )$$

At 504, process 500 may determine an error associated with each term of a closed-form solution to the second unconstrained quadratic optimization problem. Means for performing the functionality of block 504 may include a processing unit, such as processing unit 610, as shown in and described below in connection with FIG. 6. As described above in connection with block 406 of FIG. 4, the closed form solution to the second, unconstrained quadratic optimization problem may be determined by:

$${x}^{*} = {x}_{A} + {M}_{{C}_{A}} y *= {x}_{A} - {{M}_{{C}_{A}} ( {M}_{{C}_{A}}^{T} {GM}_{{C}_{A}} )}^{- 1} {M}_{{C}_{A}}^{T} ( a + {Gx}_{A} )$$

The error associated with each term may be an error associated with each matrix operation of the above equation. A matrix operation may include adding and/or multiplying matrices and/or vectors, computing an inverse of a matrix, etc. For example, there may be a first error associated with multiplying two elements in the above equation, a second error associated with computing an inverse of a matrix, etc. Each error may be determined based on characteristics associated with the matrices involved in the matrix operations. For example, an error may be based on a condition number (which may in turn depend on singular values of the matrix), the dimensions of a matrix (e.g., the dimensions of the G matrix, the dimensions of a matrix associated with the set of active constraints, or the like), etc. Additionally or alternatively, an error may be based on a matrix norm associated with the active constraint matrix. For example, the error may be based on a ratio of matrix norms, generally represented herein as θ. In some implementations, θ may be determined by:

$$θ ( A , x ) = \frac{‖ A ‖ ‖ x ‖}{‖ Ax ‖}$$

At 506, process 500 may aggregate the errors associated with each term of the second, unconstrained quadratic optimization problem to determine an error amplification factor associated with the second quadratic optimization problem. Means for performing the functionality of block 506 may include a processing unit, such as processing unit 610, as shown in and described below in connection with FIG. 6. In some embodiments, the error amplification factor may be determined by adding the errors associated with each term. In some embodiments, the error amplification factor may be determined by aggregating the errors associated with each term in the order in which the corresponding matrix operations are performed when evaluating the closed-form solution, thereby accounting for the propagation of error when evaluating the closed-form solution.

At 508, process 500 may determine an overall error based on the error amplification factor and parameters associated with the computing device solving the second, unconstrained quadratic optimization problem. Means for performing the functionality of block 508 may include a processing unit, such as processing unit 610, as shown in and described below in connection with FIG. 6. For example, in some implementations, the parameters associated with the computing device may include an address width used by the computing device, such as whether the computing device includes a 32-bit processor, 64-bit processor, etc. In some embodiments, the overall error may be determined by scaling the error amplification factor based on a metric (sometimes referred to as “machine epsilon”) that characterizes a numeric limit of the computing device.

At 510, process 500 can determine an accuracy and/or precision associated with a solution of the second, unconstrained quadratic optimization problem based on the overall error. Means for performing the functionality of block 510 may include a processing unit, such as processing unit 610, as shown in and described below in connection with FIG. 6. For example, the accuracy and/or precision may translate the overall error to a range in the units associated with the updated solution. By way of example, in an instance in which the updated solution is a distance measurement, e.g., in units of meters, the precision may specify a confidence range in distance units (e.g., meters) associated with the updated solution. Examples of precisions include +/−5 meters, +/−5 millimeters, or the like.

FIG. 6 illustrates an embodiment of a computing device 605, which can be utilized as described herein above (e.g., in association with FIGS. 2, 3, 4, and/or 5). For example, the computing device 605 can perform one or more of the functions of the method shown in any of FIGS. 3, 4, and/or 5. It should be noted that FIG. 6 is meant only to provide a generalized illustration of various components, any or all of which may be utilized as appropriate. It can be noted that, in some instances, components illustrated by FIG. 6 can be localized to a single physical device and/or distributed among various networked devices, which may be disposed at different physical locations. Furthermore, as previously noted, the functionality of the computing device discussed in the previously described embodiments may be executed by one or more of the hardware and/or software components illustrated in FIG. 6.

The computing device 605 is shown comprising hardware elements that can be electrically coupled via a bus 605 (or may otherwise be in communication, as appropriate). The hardware elements may include a processing unit(s) 610 which can include without limitation one or more general-purpose processors, one or more special-purpose processors (such as digital signal processor (DSP) chips, graphics acceleration processors, application specific integrated circuits (ASICs), and/or the like), and/or other processing structures or means. As shown in FIG. 6, some embodiments may have a separate DSP 620, depending on desired functionality. Location determination and/or other determinations based on wireless communication may be provided in the processing unit(s) 610 and/or wireless communication interface 630 (discussed below). The computing device 605 also can include one or more input devices 670, which can include without limitation one or more keyboards, touch screens, touch pads, microphones, buttons, dials, switches, and/or the like; and one or more output devices 615, which can include without limitation one or more displays (e.g., touch screens), light emitting diodes (LEDs), speakers, and/or the like.

The computing device 605 may also include a wireless communication interface 630, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the computing device 605 to communicate with other devices as described in the embodiments above. The wireless communication interface 630 may permit data and signaling to be communicated (e.g., transmitted and received) with TRPs of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 632 that send and/or receive wireless signals 634. According to some embodiments, the wireless communication antenna(s) 632 may comprise a plurality of discrete antennas, antenna arrays, or any combination thereof. The antenna(s) 632 may be capable of transmitting and receiving wireless signals using beams (e.g., Tx beams and Rx beams). Beam formation may be performed using digital and/or analog beam formation techniques, with respective digital and/or analog circuitry. The wireless communication interface 630 may include such circuitry.

Depending on desired functionality, the wireless communication interface 630 may comprise a separate receiver and transmitter, or any combination of transceivers, transmitters, and/or receivers to communicate with base stations (e.g., ng-eNBs and gNBs) and other terrestrial transceivers, such as wireless devices and access points. The computing device 605 may communicate with different data networks that may comprise various network types. For example, a Wireless Wide Area Network (WWAN) may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000, WCDMA, and so on. CDMA2000 includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. Cdma2000 is described in documents from a consortium named “3rd Generation Partnership Project X3” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The computing device 605 can further include sensor(s) 640. Sensor(s) 640 may comprise, without limitation, one or more inertial sensors and/or other sensors (e.g., accelerometer(s), gyroscope(s), camera(s), radar device(s), lidar device(s), magnetometer(s), altimeter(s), microphone(s), proximity sensor(s), light sensor(s), barometer(s), and the like), some of which may be used to obtain position-related measurements and/or other information.

Embodiments of the computing device 605 may also include a Global Navigation Satellite System (GNSS) receiver 680 capable of receiving signals 684 from one or more GNSS satellites using an antenna 682 (which could be the same as antenna 632). Positioning based on GNSS signal measurement can be utilized to complement and/or incorporate the techniques described herein. The GNSS receiver 680 can extract a position of the computing device 605, using conventional techniques, from GNSS satellites of a GNSS system, such as Global Positioning System (GPS), Galileo, GLONASS, Quasi-Zenith Satellite System (QZSS) over Japan, Indian Regional Navigational Satellite System (IRNSS) over India, BeiDou Navigation Satellite System (BDS) over China, and/or the like. Moreover, the GNSS receiver 680 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 680 is illustrated in FIG. 6 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processing units, such as processing unit(s) 610, DSP 620, and/or a processing unit within the wireless communication interface 630 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), a hatch filter, particle filter, or the like. The positioning engine may also be executed by one or more processing units, such as processing unit(s) 610 or DSP 620.

The computing device 605 may further include and/or be in communication with a memory 660. The memory 660 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 660 of the computing device 605 also can comprise software elements (not shown in FIG. 6), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 660 that are executable by the computing device 605 (and/or processing unit(s) 610 or DSP 620 within computing device 605). In an aspect, then such code and/or instructions can be used to configure and/or adapt a general-purpose computer (or other device) to perform one or more operations in accordance with the described methods.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:
Clause 1: A method of solving quadratic programming optimization problems, the method comprising: receiving, by one or more processors, a first quadratic optimization problem comprising an objective and a set of inequality constraints; obtaining, by the one or more processors, an initial solution to the first quadratic optimization problem subject to the set of inequality constraints; identifying, by the one or more processors, a subset of the set of inequality constraints that are active constraints with respect to an optimal solution; obtaining, by the one or more processors, an updated solution to the first quadratic optimization problem by solving a second quadratic optimization problem that corresponds to optimizing the objective subject to the active constraints; and determining, by the one or more processors, an accuracy and precision associated with the updated solution.
Clause 2: The method of clause 1, wherein the initial solution to the first quadratic optimization problem is obtained using the Goldfarb-Idnani algorithm, and wherein the initial solution and the active constraints are identified from a final solution-pair generated by the Goldfarb-Idnani algorithm.
Clause 3: The method of any one of clauses 1 or 2, wherein the second quadratic optimization problem is an unconstrained quadratic optimization problem.
Clause 4: The method of any one of clauses 1-3, wherein obtaining the updated solution comprises determining a closed-form solution of the second quadratic optimization problem using a series of matrix operations.
Clause 5: The method of clause 4, wherein determining the precision comprises aggregating uncertainties associated with each matrix operation of the series of matrix operations in an order corresponding to the series of matrix operations.
Clause 6: The method of clause 5, wherein an uncertainty associated with a given matrix operation is based on characteristics of one or more matrices associated with the given matrix operation.
Clause 7: The method of any one of clauses 5 or 6 wherein determining the accuracy and precision further comprises applying an error amplification factor to the aggregated uncertainties, wherein the error amplification factor is determined based on characteristics associated with the one or more processors.
Clause 8: The method of any one of clauses 1-7, further comprising providing the updated solution and the accuracy and precision associated with the updated solution to a control system, wherein the control system is configured to make at least one decision based on the accuracy and precision associated with the updated solution.
Clause 9: The method of clause 8, wherein the control system is associated with at least one of: 1) an autonomous vehicle system; or 2) a drone system.
Clause 10: The method of clause 9, wherein the updated solution corresponds to a measurement comprising at least one of: a distance measurement; a velocity measurement; an acceleration measurement; a jerk measurement; or any combination thereof, and wherein the accuracy and precision indicates an error bound on the measurement.
Clause 11: The method of any one of clauses 1-10, further comprising: performing change of variable regularization on the first quadratic optimization problem prior to obtaining the initial solution; and reversing the change of variable after obtaining the updated solution.
Clause 12: The method of clause 11, wherein performing the change of variable regularization is responsive to determining a condition number associated with a matrix of the objective exceeds a threshold.
Clause 13: A device for solving quadratic programming optimization problems, the device comprising: one or more memories; and one or more processing units communicatively coupled with the one or more memories, the one or more processing units configured to: receive a first quadratic optimization problem comprising an objective and a set of inequality constraints; obtain an initial solution to the first quadratic optimization problem subject to the set of inequality constraints; identify a subset of the set of inequality constraints that are active constraints with respect to an optimal solution; obtain an updated solution to the first quadratic optimization problem by solving a second quadratic optimization problem that corresponds to optimizing the objective subject to the active constraints; and determine an accuracy and precision associated with the updated solution.
Clause 14: The device of clause 13, wherein the initial solution to the first quadratic optimization problem is obtained using the Goldfarb-Idnani algorithm, and wherein the initial solution and the active constraints are identified from a final solution-pair generated by the Goldfarb-Idnani algorithm.
Clause 15: The device of any one of clauses 13 or 14, wherein the second quadratic optimization problem is an unconstrained quadratic optimization problem.
Clause 16: The device of any one of clauses 13-15, wherein obtaining the updated solution comprises determining a closed-form solution of the second quadratic optimization problem using a series of matrix operations.
Clause 17: The device of clause 16, wherein determining the precision comprises aggregating uncertainties associated with each matrix operation of the series of matrix operations in an order corresponding to the series of matrix operations.
Clause 18: The device of clause 17, wherein an uncertainty associated with a given matrix operation is based on characteristics of one or more matrices associated with the given matrix operation.
Clause 19: The device of any one of clauses 17 or 18, wherein determining the accuracy and precision further comprises applying an error amplification factor to the aggregated uncertainties, wherein the error amplification factor is determined based on characteristics associated with the one or more processors.
Clause 20: The device of any one of clauses 13-19, wherein the one or more processing units are further configured to provide the updated solution and the accuracy and precision associated with the updated solution to a control system, wherein the control system is configured to make at least one decision based on the accuracy and precision associated with the updated solution.
Clause 21: The device of clause 20, wherein the control system is associated with at least one of: 1) an autonomous vehicle system; or 2) a drone system.
Clause 22: The device of clause 21, wherein the updated solution corresponds to a measurement comprising at least one of: a distance measurement; a velocity measurement; an acceleration measurement; a jerk measurement; or any combination thereof, and wherein the accuracy and precision indicates an error bound on the measurement.
Clause 23: A device for solving quadratic programming optimization problems, the device comprising: means for receiving a first quadratic optimization problem comprising an objective and a set of inequality constraints; means for obtaining an initial solution to the first quadratic optimization problem subject to the set of inequality constraints; means for identifying a subset of the set of inequality constraints that are active constraints with respect to an optimal solution; means for obtaining an updated solution to the first quadratic optimization problem by solving a second quadratic optimization problem that corresponds to optimizing the objective subject to the active constraints; and means for determining an accuracy and precision associated with the updated solution.
Clause 24: The device of clause 23, wherein the initial solution to the first quadratic optimization problem is obtained using the Goldfarb-Idnani algorithm, and wherein the initial solution and the active constraints are identified from a final solution-pair generated by the Goldfarb-Idnani algorithm.
Clause 25: The device of any one of clauses 23 or 24, wherein the second quadratic optimization problem is an unconstrained quadratic optimization problem.
Clause 26: The device of any one of clauses 23-25, wherein the means for obtaining the updated solution comprises means for determining a closed-form solution of the second quadratic optimization problem using a series of matrix operations.
Clause 27: The device of any one of clauses 23-26, further comprising means for providing the updated solution and the accuracy and precision associated with the updated solution to a control system, wherein the control system is configured to make at least one decision based on the accuracy and precision associated with the updated solution.
Clause 28: The device of clause 27, wherein the control system is associated with at least one of: 1) an autonomous vehicle system; or 2) a drone system.
Clause 29: The device of clause 28, wherein the updated solution corresponds to a measurement comprising at least one of: a distance measurement; a velocity measurement; an acceleration measurement; a jerk measurement; or any combination thereof, and wherein the accuracy and precision indicates an error bound on the measurement.
Clause 30: A non-transitory computer-readable medium storing instructions for solving quadratic programming optimization problems, the instructions comprising code for: receiving a first quadratic optimization problem comprising an objective and a set of inequality constraints; obtaining an initial solution to the first quadratic optimization problem subject to the set of inequality constraints; identifying a subset of the set of inequality constraints that are active constraints with respect to an optimal solution; obtaining an updated solution to the first quadratic optimization problem by solving a second quadratic optimization problem that corresponds to optimizing the objective subject to the active constraints; and determining an accuracy and precision associated with the updated solution.
Clause 31: The non-transitory computer-readable medium of clause 30, wherein the initial solution to the first quadratic optimization problem is obtained using the Goldfarb-Idnani algorithm, and wherein the initial solution and the active constraints are identified from a final solution-pair generated by the Goldfarb-Idnani algorithm.
Clause 32: The non-transitory computer-readable medium of any one of clauses 30 or 31, wherein the second quadratic optimization problem is an unconstrained quadratic optimization problem.

What is claimed is:

1. A method of solving quadratic programming optimization problems, the method comprising:
receiving, by one or more processors, a first quadratic optimization problem comprising an objective and a set of inequality constraints;
obtaining, by the one or more processors, an initial solution to the first quadratic optimization problem subject to the set of inequality constraints;
identifying, by the one or more processors, a subset of the set of inequality constraints that are active constraints with respect to an optimal solution;
obtaining, by the one or more processors, an updated solution to the first quadratic optimization problem by solving a second quadratic optimization problem that corresponds to optimizing the objective subject to the active constraints; and
determining, by the one or more processors, an accuracy and precision associated with the updated solution.

2. The method of claim 1, wherein the initial solution to the first quadratic optimization problem is obtained using the Goldfarb-Idnani algorithm, and wherein the initial solution and the active constraints are identified from a final solution-pair generated by the Goldfarb-Idnani algorithm.

3. The method of claim 1, wherein the second quadratic optimization problem is an unconstrained quadratic optimization problem.

4. The method of claim 1, wherein obtaining the updated solution comprises determining a closed-form solution of the second quadratic optimization problem using a series of matrix operations.

5. The method of claim 4, wherein determining the precision comprises aggregating uncertainties associated with each matrix operation of the series of matrix operations in an order corresponding to the series of matrix operations.

6. The method of claim 5, wherein an uncertainty associated with a given matrix operation is based on characteristics of one or more matrices associated with the given matrix operation.

7. The method of claim 5, wherein determining the accuracy and precision further comprises applying an error amplification factor to the aggregated uncertainties, wherein the error amplification factor is determined based on characteristics associated with the one or more processors.

8. The method of claim 1, further comprising providing the updated solution and the accuracy and precision associated with the updated solution to a control system, wherein the control system is configured to make at least one decision based on the accuracy and precision associated with the updated solution.

9. The method of claim 8, wherein the control system is associated with at least one of: 1) an autonomous vehicle system; or 2) a drone system.

10. The method of claim 9, wherein the updated solution corresponds to a measurement comprising at least one of: a distance measurement; a velocity measurement; an acceleration measurement; a jerk measurement; or any combination thereof, and wherein the accuracy and precision indicates an error bound on the measurement.

11. The method of claim 1, further comprising:
performing change of variable regularization on the first quadratic optimization problem prior to obtaining the initial solution; and
reversing the change of variable after obtaining the updated solution.

12. The method of claim 11, wherein performing the change of variable regularization is responsive to determining a condition number associated with a matrix of the objective exceeds a threshold.

13. A device for solving quadratic programming optimization problems, the device comprising:
one or more memories; and
one or more processing units communicatively coupled with the one or more memories, the one or more processing units configured to:
receive a first quadratic optimization problem comprising an objective and a set of inequality constraints;
obtain an initial solution to the first quadratic optimization problem subject to the set of inequality constraints;
identify a subset of the set of inequality constraints that are active constraints with respect to an optimal solution;
obtain an updated solution to the first quadratic optimization problem by solving a second quadratic optimization problem that corresponds to optimizing the objective subject to the active constraints; and
determine an accuracy and precision associated with the updated solution.

14. The device of claim 13, wherein the initial solution to the first quadratic optimization problem is obtained using the Goldfarb-Idnani algorithm, and wherein the initial solution and the active constraints are identified from a final solution-pair generated by the Goldfarb-Idnani algorithm.

15. The device of claim 13, wherein the second quadratic optimization problem is an unconstrained quadratic optimization problem.

16. The device of claim 13, wherein obtaining the updated solution comprises determining a closed-form solution of the second quadratic optimization problem using a series of matrix operations.

17. The device of claim 13, wherein the one or more processing units are further configured to provide the updated solution and the accuracy and precision associated with the updated solution to a control system, wherein the control system is configured to make at least one decision based on the accuracy and precision associated with the updated solution.

18. The device of claim 17, wherein the control system is associated with at least one of: 1) an autonomous vehicle system; or 2) a drone system.

19. The device of claim 18, wherein the updated solution corresponds to a measurement comprising at least one of: a distance measurement; a velocity measurement; an acceleration measurement; a jerk measurement; or any combination thereof, and wherein the accuracy and precision indicates an error bound on the measurement.

20. A device for solving quadratic programming optimization problems, the device comprising:
means for receiving a first quadratic optimization problem comprising an objective and a set of inequality constraints;
means for obtaining an initial solution to the first quadratic optimization problem subject to the set of inequality constraints;
means for identifying a subset of the set of inequality constraints that are active constraints with respect to an optimal solution;
means for obtaining an updated solution to the first quadratic optimization problem by solving a second quadratic optimization problem that corresponds to optimizing the objective subject to the active constraints; and
means for determining an accuracy and precision associated with the updated solution.
